(19) United States
(12) Patent Application Publication
(10) Pub. No.: US 2020/0185173 A1
(43) Pub. Date: Jun. 11, 2020

(54) DIAGNOSTIC TOOL FOR CIRCUIT INTERRUPTION IN PRESSURE SWITCHES

(71) Applicant: Jonathan Kane Roberts, Brighton, MI (US)

(72) Inventor: Jonathan Kane Roberts, Brighton, MI (US)

(21) Appl. No.: 16/709,172

(22) Filed: Dec. 10, 2019

Related U.S. Application Data
(60) Provisional application No. 62/917,477, filed on Dec. 11, 2018.

(51) Int. Cl. H01H 35/26; H01H 11/00

(52) U.S. Cl. CPC H01H 35/265; H01H 11/0062

(57) ABSTRACT

Embodiments herein are directed to a portable diagnostic tool. The portable diagnostic tool includes a tool body, a first hexagonal shape, a second hexagonal shape, and a plurality of legs. The tool body has four peripheral edges, a top face and a bottom face positioned on an opposite side of the tool body. The first and second hexagonal shapes are disposed within the tool body extending through the top face and the bottom face. The second hexagonal shape is larger than the first hexagonal shape. Each of the plurality of legs extend from the same one of the four peripheral edges. Each of the plurality of legs are spaced apart and extend an equal length. Each one of the plurality of legs has a first surface and a second surface. The second surface has a tapered portion with respect to the first surface.

### CROSS REFERENCE TO RELATED APPLICATIONS

The present utility application patent application claims priority benefit of the U.S. provisional application for Ser. No. 62/917,477 filed on Dec. 11, 2018, the entire contents of which is incorporated herein in its entirety.

### TECHNICAL FIELD

The present disclosure generally relates to portable diagnostic tools and, more specifically, to portable diagnostic tools for circuit interruption in pressure switches to diagnose pump systems.

### BACKGROUND

Pressure switches are devices used in pumping systems that detect an amount of pressure within the system and sends either an on signal or an off signal to a pump to regulate the pressure between a cut-in pressure and a cut-off pressure. The pressure switch is generally factory set with a lower limit or cut-in pressure and an upper limit, or cut-off pressure. Pressure switches generally include at least one adjustment spring and contacts. The contacts open and close based on the pressure setting on the switch and the pressure setting going into the pressure switch. The at least one adjustment spring sets the predetermined pressure settings. The contacts are electrically powered by an outside source and the pressure switch electrically powers the pump. By their nature, pressure switches and pumps are generally positioned in areas where access is limited. As such, troubleshooting pump systems is difficult and conventional diagnostic tools are generally configured to perform diagnostic procedures on the pump itself, which requires several different tools to perform a proper diagnostic test.

Accordingly, there is a need for a portable diagnostic tool that assists in performing diagnostic procedures on the pump system from through the pressure switch, that is easy to carry, that is easy to use in limited access areas, and which incorporates several tools into a single portable format.

### SUMMARY

In one aspect, a portable tool is provided. The portable diagnostic tool includes a tool body, a first hexagonal shape, a second hexagonal shape, and a plurality of legs. The tool body has at least one peripheral edge, a top face and a bottom face positioned on an opposite side of the tool body to define a thickness. The first hexagonal shape is disposed within the tool body extending through the top face and the bottom face. The second hexagonal shape is disposed within the tool body extending through the top face and the bottom face side. The second hexagonal shape is larger than the first hexagonal shape. The plurality of legs each extend from the at least one peripheral edge. Each one of the plurality of legs has a first surface and a second surface. The second surface has a tapered portion with respect to the first surface.

In another aspect, a system is provided. The system includes a pressure switch and a portable diagnostic tool. The pressure switch includes a power circuit that includes a plurality of terminals and a corresponding plurality of contacts movable between an engaged position and an open position such that in the engaged position the power circuit supplies a power to a pump. The portable diagnostic tool includes a tool body, a first hexagonal shape, a second hexagonal shape, and a plurality of legs. The tool body has at least one peripheral edge, a top face and a bottom face positioned on an opposite side of the tool body. The first hexagonal shape is disposed within the tool body extending through the top face and the bottom face. The second hexagonal shape is disposed within the tool body extending through the top face and the bottom face side. The second hexagonal shape is larger than the first hexagonal shape. The plurality of legs each extend from the at least one peripheral edge. Each of the plurality of legs are spaced apart and extend an equal length from the at least one peripheral edge. Each one of the plurality of legs has a first surface and a second surface. The second surface has a tapered portion with respect to the first surface. Each one of the plurality of legs is configured to be inserted between the plurality of terminals and the plurality of contacts such that the plurality of contacts are moved to the open position to interrupt the power supplied to the pump.

In yet another aspect, a method of interrupting power supplied to a pump by a pressure switch for diagnostic testing is provided. The method includes removing, by a first hexagonal shape of a portable diagnostic tool, a nut of a housing cover to remove the housing cover from the pressure switch and moving a diaphragm plate of the pressure switch to move the plurality of contact members from a first position to a second position creating a gap between the plurality of contact members and a corresponding terminal member of a plurality of terminals of the pressure switch. The method continues by inserting the legs of the portable diagnostic tool between the corresponding terminal member of the plurality of terminals and the plurality of contact members such that the plurality of contact members are prevented from making contact with the corresponding terminal member and such that an abrasive surface of the legs cleans a carbon buildup on the each one of the corresponding terminal members.

These and additional objects and advantages provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a pump system that includes a portable diagnostic tool removing a nut from a housing of an example pressure switch assembly according to one or more embodiments shown or described herein;

FIG. 2 schematically depicts a perspective view of the portable diagnostic tool adjusting a nut of an adjustment spring of the example pressure switch assembly of FIG. 1 according to one or more embodiments shown or described herein;

FIG. 3 schematically depicts a perspective view of the portable diagnostic tool inserted between contacts of the example pressure switch assembly of FIG. 1 according to one or more embodiments shown or described herein;

FIG. 4A schematically depicts a partial cross section view of the portable diagnostic tool inserted between contacts of the example pressure switch assembly of FIG. 3 taken from line 4-4 according to one or more embodiments shown or described herein;

FIG. 4B schematically depicts a partial cross section view of the portable diagnostic tool removed from between contacts of the example pressure switch assembly of FIG. 3 taken from line 4-4 according to one or more embodiments shown or described herein;

FIG. 5 schematically depicts a perspective isolated view of the portable diagnostic tool of FIG. 1 according to one or more embodiments shown or described herein;

FIG. 6 schematically depicts a front isolated view of the portable diagnostic tool of FIG. 1 according to one or more embodiments shown or described herein;

FIG. 7 schematically depicts a rear isolated view of the portable diagnostic tool of FIG. 1 according to one or more embodiments shown or described herein; and

FIG. 8 depicts a flowchart of an illustrative method of diagnosing the pump system through the example pressure switch assembly of FIG. 1 according to one or more embodiments shown or described herein.

### DETAILED DESCRIPTION

The present disclosure is directed to a portable diagnostic tool for use in circuit interruption in pump systems such that the pump system may be diagnosed to determine root cause of presently occurring failure. The portable diagnostic tool includes a tool body. The tool body includes four peripheral edges, a top face and a bottom face positioned on an opposite side of the tool body to define a thickness less than 1.5 millimeters. The top and bottom faces are each substantially flat. At least one of the four peripheral edges is curvilinear. A first hexagonal shape is disposed within the tool body extending through the top face and the bottom face. The first hexagonal shape is configured as a first wrench. A second hexagonal shape is disposed within the tool body extending through the top face and the bottom face side. The second hexagonal shape is larger than the first hexagonal shape. The second hexagonal shape is configured as a second wrench. The at least one curvilinear peripheral edge provides the necessary clearance for the second wrench. A plurality of legs extend from one of the four peripheral edges. Each of the plurality of legs are spaced apart and extend an equal length from the one of the four peripheral edges.

Each one of the plurality of legs has a first surface and an opposite second surface. The second surface has a tapered portion with respect to the first surface. The tapered portion of each one of the plurality of legs is positioned at an end opposite of the peripheral edge. Each one of the plurality of legs further includes an abrasive surface on the first surface. Each one of the plurality of legs is configured to be inserted within a plurality of terminals of a power circuit of the pressure switch to interrupt the power supplied to a pump within the pump system. During insertion, the abrasive surface on the first surface of each one of the plurality of legs is configured to remove a carbon buildup on each one of the plurality of terminals.

As used herein, the term “communicatively coupled” means that coupled components are capable of exchanging data signals, power such as electricity, voltage, current, electrons, and the like, with one another such as, for example, electrical signals via conductive medium or a non-conductive medium, though networks such as via Wi-Fi, Bluetooth, and the like, electromagnetic signals via air, optical signals via optical waveguides, and the like.

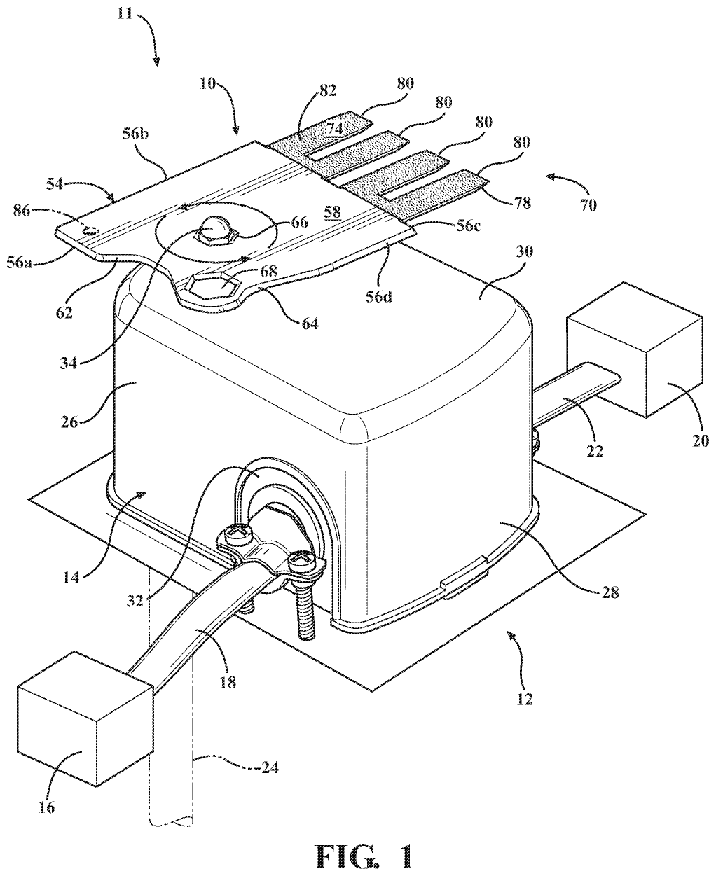

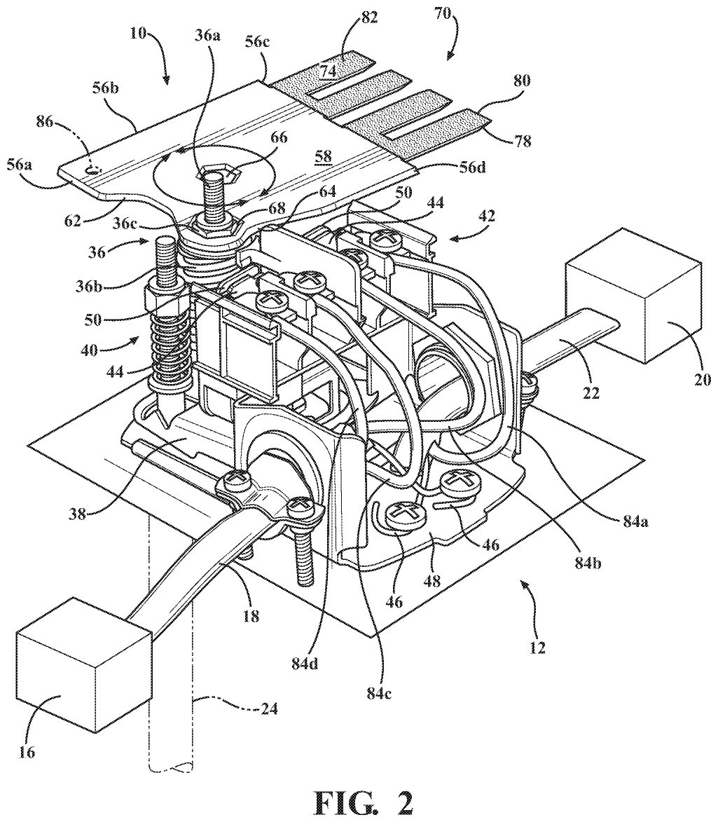

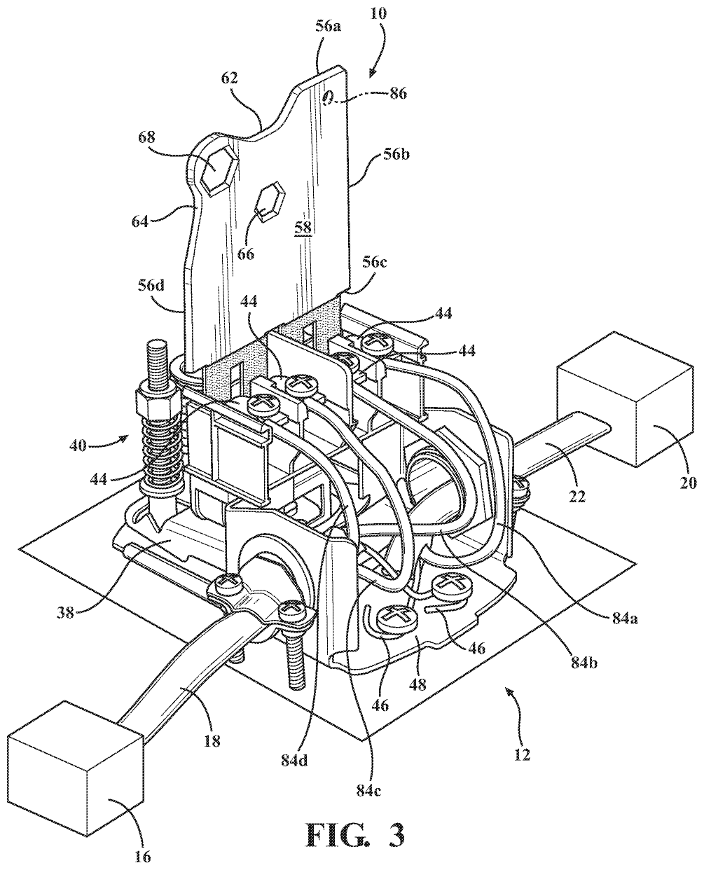

Referring to FIGS. 1-4B, an illustrative pump system 11 is schematically depicted. The pump system 11 includes a portable diagnostic tool 10, an example pressure switch assembly 12, a voltage source 16 and a pump 20. The example pressure switch assembly 12 includes a housing 14 that encases or encloses many components of the example pressure switch assembly 12. The example pressure switch assembly 12 is communicatively coupled to the voltage source 16 via a first wire bundle 18. The voltage source may include a breaker panel with a plurality of circuit breakers. The example pressure switch assembly 12 is also communicatively coupled to the pump 20 via a second wire bundle 22. The pump 20 may be a fluid pump such as an air compressor, a water pump, and the like. The pump 20 may include a motor that drives the pump 20, generates a pressure, and the like, and/or forces fluid through a plurality of pipes, containers, vessels and the like. It should be appreciated that the example pressure switch assembly 12 may also be communicatively and/or fluidly coupled to a pipe 24, or other fluid container. In some embodiments, the fluid container holds a pressure.

The housing 14 includes a pair of sidewalls 26, a pair of end walls 28, and a roof surface 30 that encloses the components of the example pressure switch assembly 12. Each of the pair of sidewalls 26 may include a cutout portion 32 to allow the first and second wire bundles 18, 22 to enter into the housing 14. Further, the roof surface 30 includes a housing nut 34 that is configured to engage with a threaded portion 36a of an adjustment spring mechanism 36. The adjustment spring mechanism 36 also includes a spring 36b, and a pressure adjustment nut 36c. The pressure adjustment nut 36c compresses or allows the spring 36b to expand, which in turn positions a diaphragm plate 38 that sets an upper limit pressure limit. As such, it should be appreciated by rotating the pressure adjustment nut 36c, the upper limit of the pressure is modified. The example pressure switch assembly 12 further includes a second pressure adjustment mechanism 40 that is configured to allow a differential in pressure to be adjusted.

The example pressure switch assembly 12 further includes a power circuit 42. The power circuit 42 includes a plurality of terminals 44 configured to receive power from the voltage source 16 and distribute power to the pump 20. It should be appreciated that while the plurality of terminals 44 are illustrated as four terminals, this is non-limiting and there may be more or fewer terminals within the example pressure switch assembly 12. Further, the example pressure switch assembly 12 includes a pair of ground wires 46 attached to a plate 48 of the example pressure switch assembly 12. It is understood that one ground wire is from the voltage source 16 and the other ground wire is from the pump 20. Further, each of the plurality of terminals 44 includes a terminal member 45 and load wire 84a, 84b, 84c, 84d communicatively coupled thereon. In the illustrated embodiment, two of the load wires 84b, 84c, are within the first wire bundle 18 and provide power to the power circuit 42 from the voltage source 16. Further, two of the load wires 84a, 84d are within the second wire bundle 22 and provide power from the power circuit 42 to the pump 20. It is understood that this is a non-limiting example and as the two load wires 84a, 84d may provide power to the power circuit 42 from the voltage source 16 and the two of the load wires 84b, 84c may provide power from the power circuit 42 to the pump 20.

The example pressure switch assembly 12 further includes a plurality of contact members 50 arranged along a single plane and connected by a contact plate 52. As such, each contact member of the plurality of contact members 50 are configured to move in unison between a first position, otherwise known as a normally closed position, where each contact member of the plurality of contact members 50 are communicatively coupled to a corresponding terminal member 45 for each of the plurality of terminals 44 of the example pressure switch assembly 12, and a second position, otherwise known as an open position, where there is not contact between the plurality of contact members 50 and the corresponding terminal member 45 of the plurality of terminals 44 of the example pressure switch assembly 12. In some embodiments, the contact plate 52 may transfer electricity, voltage, current, and the like, between the various plurality of contact members 50.

In operation, the example pressure switch assembly 12 provides power to the motor and/or the pump 20 via the second wire bundle 22 when pressure is required as determined by the predetermined pressure limits. As such, when pressure is needed, the plurality of contact members 50 and, in particular, each of the plurality of contact members 50 is moved, via the contact plate 52, from the second position to the first position such that each of the plurality of contact members 50 communicatively couple to the corresponding terminal member 45 of the plurality of terminals 44. Once communicatively coupled, power passes though the plurality of terminals 44, through the corresponding terminal member 45, into the plurality of contact members 50 and to the pump 20 via the load wires 84b, 85c and second wire bundle 22, in which the pump 20 generates pressure to increase the pressure in the system 11. This continues until the predetermined upper limit is reached in which case the contact plate 52 moves the plurality of contact members 50 to the second position such that there is a break between each of the plurality of contact members 50 and the corresponding terminal member 45 of the plurality of terminals 44. This movement continues for every pump cycle.

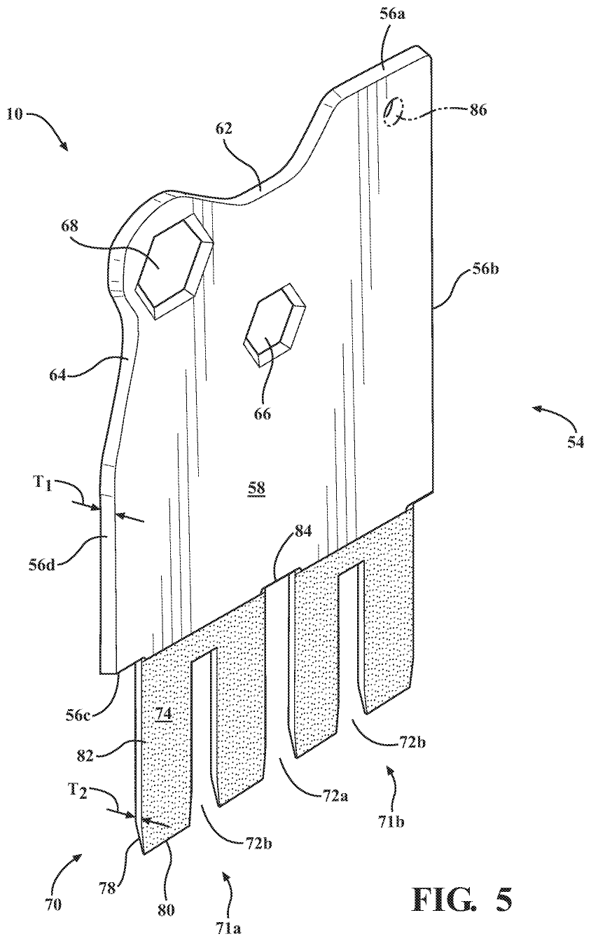

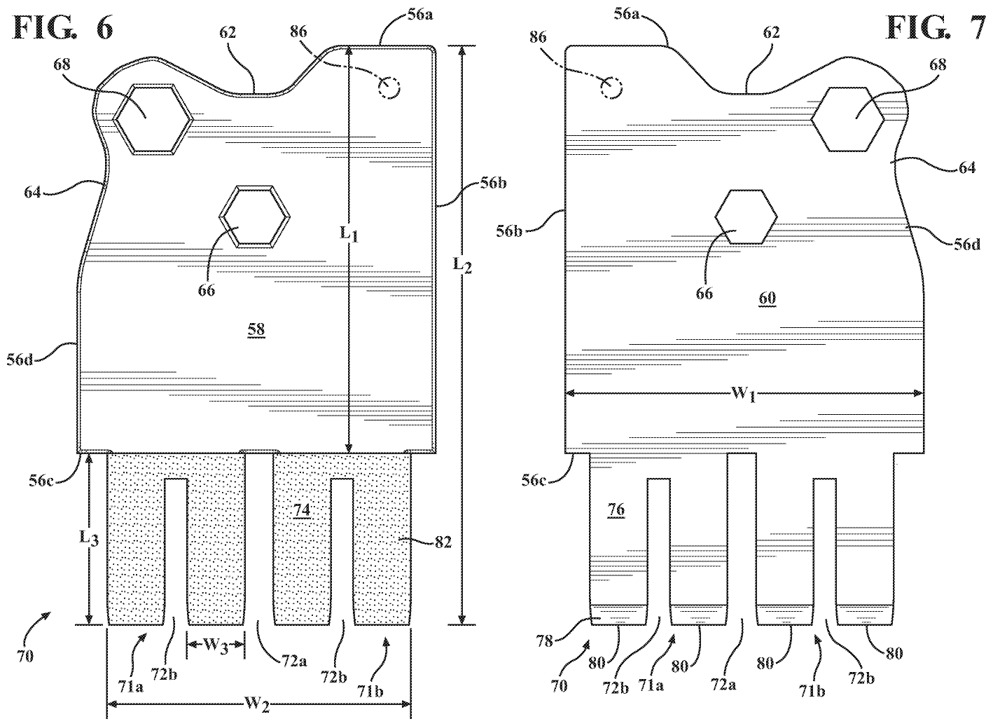

Still referring to FIGS. 1-4B, now also referring to FIGS. 5-7, when the motor and/or the pump 20 is continuously running, does not run, and the like, the pump system 11 needs to be diagnosed for root causes of the presently occurring issue(s) and/or failure(s). The portable diagnostic tool 10 may be used to facilitate diagnostic testing and/or adjustments of the pump system 11 through the example pressure switch assembly 12. For example, the portable diagnostic tool 10 may be used to adjust a pressure, to remove the housing 14 of the example pressure switch assembly 12, and for use in circuit interruption of the power circuit 42 such that the pump system 11 may be diagnosed through the example pressure switch assembly 12. For example, a continuity from the pump 20 may now be tested, a ground in the pump wiring may be verified, ohms may be checked, a voltage received, a motor startup and run amperage may be verified, and the like, as discussed in greater detail herein.

The portable diagnostic tool 10 includes a tool body 54. The tool body 54 includes four peripheral edges 56a, 56b, 56c, 54d, a top face 58 and a bottom face 60 positioned on an opposite side of the tool body 54 to define a thickness T1. In some embodiments, the thickness T1 is less than 1.5 millimeters. In other embodiments, the thickness may be greater than or equal to 1.5 millimeters.

Further, in some embodiments, the longest portion of a length L1 of the tool body 54 of the portable diagnostic tool 10 is less than 60 millimeters. In other embodiments, the length L1 of the tool body 54 of the portable diagnostic tool 10 is greater than or equal to 60 millimeters. Further yet, in some embodiments, the width W1 of the tool body 54 of the portable diagnostic tool 10 at the widest portion is less than 54 millimeters. In other embodiments, the width W1 of the tool body 54 of the portable diagnostic tool 10 is greater than or equal to 54 millimeters. The top and bottom faces 58, 60 are each substantially flat. As such, it should be appreciated that in some embodiments, the tool body 54 may be a similar size as a credit card. As such, this enables the portable diagnostic tool 10 to be easily stored and carried by the user.

In some embodiments, at least one of the peripheral edges 56a, 56b, 56c, 56d may be curvilinear such that at least one of the peripheral edges 56a, 56b, 56c, 56d includes a recess or curvilinear portion. For instance, the peripheral edge 56a may have a curvilinear portion 62. The curvilinear portion 62 may be an indention or a recess such that the length L1 at the curvilinear portion 62 is less than the length L1 of the tool body 54. Further, the peripheral edge 56d may have a curvilinear portion 64. The curvilinear portion 62 may also be an indention or a recess such that the width W1 at the curvilinear portion 62 is less than the width W1 of the tool body 54.

The tool body 54 may further include a first hexagonal shape 66 and extending through the top face 58 and the bottom face 60. In some embodiments, the first hexagonal shape 66 is configured as a first wrench. As such, the first hexagonal shape 66 may receive a nut such that the nut is locked within the first hexagonal shape 66. When the tool body 54 is rotated, the nut is also rotated such that the nut may be loosened or tightened, similar to a wrench. In some embodiments, the first hexagonal shape 66 is sized, or shaped dimensionally, to the size of the housing nut 34 such that the housing nut 34 may engage with the first hexagonal shape 66 such that the housing nut 34 may be loosened or tightened with rotation of the tool body 54.

The tool body 54 may further include a second hexagonal shape 68 and extending through the top face 58 and the bottom face 60. In some embodiments, the second hexagonal shape 68 is configured as a second wrench. As such, the second hexagonal shape 68 may receive a nut such that the nut is locked within the second hexagonal shape 68. When the tool body 54 is rotated, the nut is also rotated such that the nut may be loosened or tightened, similar to a wrench. In some embodiments, the second hexagonal shape 68 is sized, or shaped dimensionally, to the size of the pressure adjustment nut 36c such that the pressure adjustment nut 36c may engage with the second hexagonal shape 68 such that the pressure adjustment nut 36c may be loosened or tightened with rotation of the tool body 54. In some embodiments, the second hexagonal shape 68 is dimensionally larger than the first hexagonal shape 66. It should also be appreciated that the curvilinear portions 62, 64 of the peripheral edges 56a, 56d respectively, provides the necessary clearance for the tool body 54 to rotate while the second hexagonal shape 68 is engaged with the pressure adjustment nut 36c.

A plurality of legs 70 extend from the peripheral edge 56c of the tool body 54. It should be appreciated that the peripheral edge 56c is opposite the peripheral edge 56a and opposite of the curvilinear portion 62. It should be appreciated that in some embodiments, the plurality of legs 70 is a single leg that extends a portion of the length of the peripheral edge 56c or the entire length of the peripheral edge 56c. Each of the plurality of legs 70 are spaced apart and extend an equal length L3 from the peripheral edge 56c. In other embodiments, some or all of the plurality of legs 70 extend different or varying lengths. In some embodiments, a leg length L3 is less than 25 millimeters. In other embodiments, the leg length L3 is greater than or equal to 25 millimeters. As such, in some embodiments, an overall length L2 of the portable diagnostic tool 10 includes both the first length L1 and the leg length L3, which is less than 85 millimeters. In other embodiments, the overall length L2 of the portable diagnostic tool 10 is greater than or equal to 85 millimeters. It should be appreciated that, in some embodiments, the overall length may be the largest length portion and there may be additional portion of length that are less than the overall length. It should be appreciated that the overall length permits the portable diagnostic tool 10 to be stored in a user's wallet, pocket, and the like.

In some embodiments, as illustrated, the plurality of legs 70 are separated into two pairs of identical legs 71a, 71b. As such, a first gap 72a is defined between the two pair of legs 71a, 71b. In some embodiments, the first gap 72a extends into the peripheral edge 56c at a first gap recess 84. Further, each of the pair of legs 71a, 71b are spaced apart defining a second gap 72b. In some embodiments, the second gap 72b is smaller or has less of a width than the first gap 72a. Further, each of the second gaps 72b do not extend to the peripheral edge 56c such that the length of each of the second gaps 72b is less than the first gap 72a, which extends to the peripheral edge 56c. As such, the legs and the spacing is generally uniform.

Further, in some embodiments, the first gap 72a, the second gap 72b and each of the pair of legs 71a, 71b define a second width W2. In some embodiments, the second width W2 is less than the first width W1. Further, in some embodiments, the second width W2 of the plurality of legs 70 is less than 44 millimeters. In other embodiments, the second width W2 of the plurality of legs 70 is greater than or equal to 44 millimeters. It should be appreciated that the overall length L2, the width W1, and the width W2 permits the portable diagnostic tool 10 to be stored in the user's wallet, pocket, and the like.

Further, in some embodiments, each leg of the plurality of legs 70 has a thickness T2 and a third width W3. In some embodiments, the thickness T2 is less than 1.5 millimeters. In other embodiments, the thickness T2 is greater than or equal to 1.5 millimeters. As such, in some embodiments, it should be appreciated that each of the plurality of legs 70, thickness T2 is less than the thickness T1 of the tool body 54 and vice versa. In some embodiments, the third width W3 is less than 7 millimeters. In other embodiments, the third width W3 is greater than or equal to 7 millimeters. As such, the third width W3 is less than the second width W2, It should be appreciated that the present disclosure is not limited to the embodiments as illustrated herein and that there could be more or less than two pair of legs, the gaps, the lengths, the widths, the thicknesses as described herein may each or all be uniform or irregular, and the like.

Each one of the plurality of legs 70 has a first surface 74 and an opposite second surface 76. The second surface 76 has a tapered portion 78 with respect to the first surface 74. The tapered portion 78 of the plurality of legs 70 are positioned at a distal end 80 of the plurality of legs 70, or at an end opposite of the peripheral edge 56c. The first surface 74 further includes an abrasive surface 82. The abrasive surface 82 may be a textured surface such as sandpaper, grit, and the like, may be formed from a chemical compound such as hard crystals, and/or the like. It should be understood that the abrasive surface 82 is configured to make contact with the terminal member 45 of the plurality of terminals 44 and/or the plurality of contact members 50 to remove residue, such as carbon or other material that may affect continuity, resistance, voltage, and the like, between the terminal member 45 of the plurality or terminals 44 and the plurality of contact members 50 when the plurality of contact members 50 are in the first position.

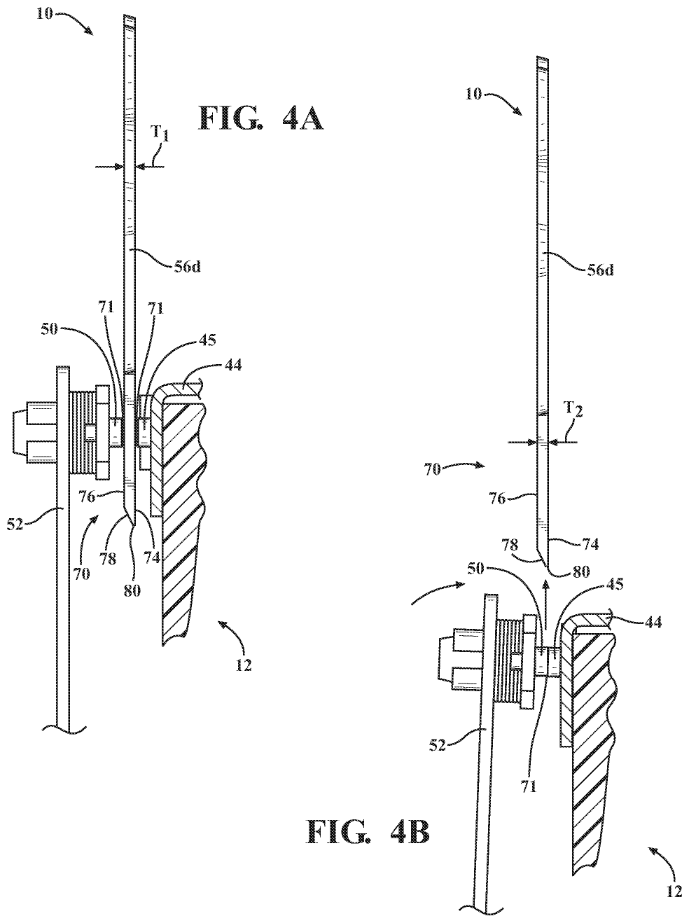

As such, each one of the plurality of legs 70 is configured to be inserted between the plurality of terminals 44 and the plurality of contact members 50, as best shown in FIGS. 4A-4B, to interrupt the power supplied to the pump 20. During insertion, the abrasive surface on the first surface of each one of the plurality of legs is configured to remove a carbon buildup 71 on each one of the plurality of terminals and/or each one of the plurality of contact members 50.

In some embodiments, the tool body 54 further includes an aperture 86. In some embodiments, the aperture 86 may be positioned near one of the four peripheral edges 56a, 56b, 56c, 56d. In other embodiments, the aperture 86 is positioned anywhere within the tool body 54. The aperture may be used to couple the tool body 54 to an object such as a rope, a string, a key ring and the like.

In some embodiments, the tool body 54 of the portable diagnostic tool 10 may be a plastic material such as a polymer, a polyetheretherketone (PEEK), and the like materials. In other embodiments, the tool body 54 of the portable diagnostic tool 10 may be materials suitable for injection molding such as Acrylonitrile Butadiene Styrene, Polyethylene, Polyamide (Nylon), High Impact Polystyrene, Polypropylene, and the like. In other embodiments, the tool body 54 of the portable diagnostic tool 10 may be a steel, a composite metal, and the like.

Further, in some embodiments, the plurality of legs 70 of the portable diagnostic tool 10 may be a plastic material such as a polymer, a polyetheretherketone (PEEK), and the like materials. In other embodiments, the plurality of legs 70 of the portable diagnostic tool 10 may be materials suitable for injection molding such as Acrylonitrile Butadiene Styrene, Polyethylene, Polyamide (Nylon), High Impact Polystyrene, Polypropylene, and the like. In other embodiments, the plurality of legs 70 of the portable diagnostic tool 10 may be insulating material such as glass, paper, Teflon, and the like, such that at least the plurality of legs 70 do not conduct electricity.

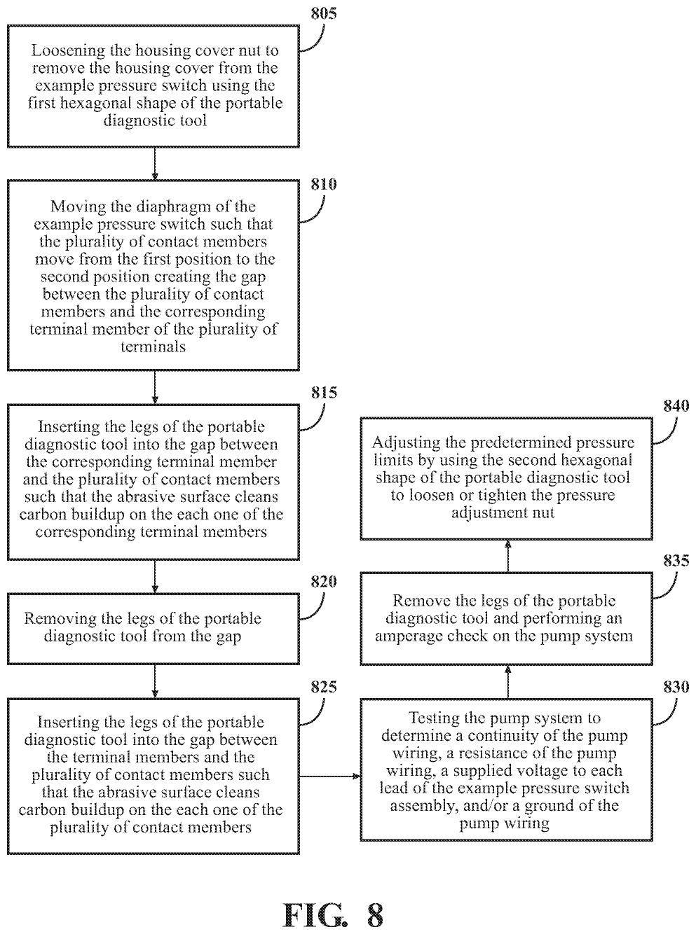

Now referring to FIG. 8, a flowchart of an illustrative method 800 of diagnosing a pump system through an example pressure switch assembly is provided. It should be appreciated that the portable diagnostic tool is used to facilitate a diagnostic testing of the pump system by interrupting a power supplied by the example pressure switch to the pump. For example, once the power is interrupted, a technician may work backwards from the pump to verify continuity through the pump, check for ground in the pump wiring and/or in the example pressure switch assembly wiring, check for opens or shorts in the pump wiring and/or in the example pressure switch assembly wiring, check a resistance or ohm test at the pump, through the pump wiring and/or in the example pressure switch assembly wiring, and the like, without the need of continually disconnecting/reconnecting power supplied from the voltage source (i.e., a toggling a circuit breaker in a breaker box). Further, an amperage check may be performed on the pump system by removing the portable diagnostic tool from the example pressure switch, which eliminates the need for the technician to continually return to the voltage source (i.e., a toggling a circuit breaker in a breaker box) and which will provide the technician with a motor start-up amperage and motor run amperage while still at the example pressure switch assembly.

The method of diagnosing the pump system through the example pressure switch assembly begins, at block 805, by loosening, with the first hexagonal shape of the portable diagnostic tool, the housing cover nut to remove the housing cover from the example pressure switch exposing the power circuit and the pressure adjustment mechanism. The diaphragm plate of the example pressure switch is moved, at block 810, such that the corresponding contact members of the plurality of contact members move from the first position (normally closed) to the second position (open) creating the gap between the corresponding contact members of plurality of contact members and the corresponding terminal member of the plurality of terminals of example the pressure switch. The legs of the portable diagnostic tool are inserted into the gap between the corresponding terminal members of the plurality of terminals and the plurality of contact members, at block 815. As such, the corresponding contact member of the plurality of contact members are prevented from making contact with, or passing electricity, power, voltage, current, and the like, to the corresponding terminal member of the plurality of terminals, which interrupts the power supplied to the pump of the pump system. Further, the abrasive surface makes contact with and cleans a carbon buildup, and other residue, on the each one of the corresponding terminal members of the plurality of terminals. It should be appreciated that the portable diagnostic tool may have one leg or a plurality of legs. Further, the one leg or the plurality of legs may be configured to interrupt the power supplied to the pump of the pump system between one or the plurality of contact members and one or the plurality of terminals members.

At block 820, the legs of the portable diagnostic tool are removed from the gap between the plurality of contact members and the plurality of terminals such that the abrasive surface continues and cleans the carbon buildup and other residue on the corresponding terminal members of the plurality of terminals. At block 825, the legs of the portable diagnostic tool are reinserted into the gap between the corresponding terminal member of the plurality of terminals and the corresponding contact of the plurality of contact members such that the plurality of contact members are prevented from making contact with the plurality of terminals in the same manner as discussed above. Further, the abrasive surface of the legs cleans carbon buildup and other residue on each one of the plurality of contact members.

It should be appreciated that blocks 815-825 are interchangeable. As such, the abrasive surface may first face the plurality of contacts and clean the plurality of contacts then be removed and reinserted such that the abrasive surface makes contact with the plurality of terminals.

At block 830, testing the pump of the pump system to determine a continuity of the pump wiring of the pump, a resistance of the pump wiring of the pump, a supplied voltage to each lead of the example power switch assembly, a ground and a short at the example pressure switch and/or of the pump wiring of the pump, and the like is performed. At block 835, the legs of the portable diagnostic tool are removed from the gap and an amperage check is performed on the pump system. It should be appreciated that the amperage check is performed on the pump system without requiring the technician to go to the voltage source to energize the system. Further, it should be understood that the amperage check allows the technician to determine a starting amperage of the pump as well as a running amperage. This data permits the technician to determine the health of the motor of the pump.

That is, if the starting amperage continues to climb, the motor of the pump may be seized. If the starting amperage is higher but settles over a predetermined time, the motor of the pump may be working properly and the present issue may be a fluid issue and not mechanical to the motor or electrical to the pump wires. It should be appreciated by those skilled in the art that the portable diagnostic tool assists in facilitating the amperage check immediately at startup, before a possible circuit breaker trip or other fault occurring in the pump system that may not otherwise be detectable with the technician going to the voltage source to establish power to the pump system (i.e., toggling the breaker at the breaker panel).

That is, if one of the symptoms of the present failure is the circuit breaker trip, the technician, using the portable diagnostic tool, would be able to insert the tool as described with respect to blocks 805-825 above, then when the power is supplied back to the system, the breaker would not trip because of the circuit interruption and the technician perform the diagnostic tests as discussed herein and may gather a startup amperage of the motor and a motor run amperage when the portable diagnostic tool is removed and before the breaker trips again. At block 840, the second hexagonal shape of the portable diagnostic tool adjusts the predetermined pressure limits by loosening or tightening the pressure adjustment nut.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A portable tool comprising:
a tool body having at least one peripheral edge, a top face and a bottom face positioned on an opposite side of the tool body to define a thickness,
a first hexagonal shape disposed within the tool body extending through the top face and the bottom face;
a second hexagonal shape disposed within the tool body extending through the top face and the bottom face, the second hexagonal shape larger than the first hexagonal shape; and
a plurality of legs each extending from the at least one peripheral edge, each one of the plurality of legs has a first surface and a second surface, the second surface has a tapered portion with respect to the first surface.

2. The portable tool of claim 1, wherein the top and bottom faces each being substantially flat to define a uniform thickness less than 1.5 millimeters.

3. The portable tool of claim 1, wherein the tapered portion of each one of the plurality of legs is positioned at a distal end of each of the plurality of legs, the distal end is an opposite end from the at least one peripheral edge from which the plurality of legs extend.

4. The portable tool of claim 3, wherein:
each of the plurality of legs are spaced apart and extend an equal length from the at least one peripheral edge, and
each one of the plurality of legs further includes an abrasive surface on the first surface.

5. The portable tool of claim 4, wherein the tool body includes a second peripheral edge, the second peripheral edge has at least one curvilinear portion.

6. The portable tool of claim 5, further comprises:
a power circuit having a plurality of terminals and a corresponding plurality of contact members movable between an engaged position and an open position such that in the engaged position, the power circuit supplies a power to a pump,
wherein each one of the plurality of legs is configured to be inserted between the plurality of terminals and the plurality of contact members such that the plurality of legs interrupt the power supplied to the pump.

7. The portable tool of claim 5, wherein the abrasive surface on the first surface of each one of the plurality of legs is configured to remove a carbon buildup on each one of the plurality of terminals and each one of the plurality of contact members.

8. The portable tool of claim 7, wherein the first hexagonal shape is sized to fit a nut of a housing cover of the power circuit such that the first hexagonal shape loosens and tightens the nut of the housing cover.

9. The portable tool of claim 7, wherein the second hexagonal shape is sized to fit a nut of an adjustment pressure valve of the power circuit such that the second hexagonal shape adjusts the nut position which in turn sets a pressure limit for the power circuit.

10. A system comprising:
a pressure switch comprising:
a power circuit having a plurality of terminals and a corresponding plurality of contact members movable between an engaged position and an open position such that in the engaged position, the power circuit supplies a power to a pump;
a portable diagnostic tool comprising:
a tool body having at least one peripheral edge, a top face and a bottom face positioned on an opposite side of the tool body,
a first hexagonal shape disposed within the tool body extending through the top face and the bottom face;
a second hexagonal shape disposed within the tool body extending through the top face and the bottom face side, the second hexagonal shape is larger than the first hexagonal shape; and
at least one leg extending from the at least one peripheral edge,
wherein the at least one leg is configured to be inserted between the plurality of terminals and the plurality of contact members such that the plurality of contact members are held in the open position to interrupt the power supplied to the pump.

11. The system of claim 10, wherein the top and bottom faces each being substantially flat to define a uniform thickness less than 1.5 millimeters.

12. The system of claim 10, wherein the at least one leg has a first surface and a second surface, the second surface has a tapered portion with respect to the first surface.

13. The system of claim 12, wherein the tapered portion of the at least one leg is positioned at a distal end, the distal end is an opposite end from the at least one peripheral edge from which the at least one leg extends.

14. The system of claim 13, wherein the at least one leg further includes an abrasive surface on the first surface.

15. The system of claim 14, wherein the abrasive surface on the first surface of the at least one leg is configured to remove a carbon buildup on each one of the plurality of terminals and the plurality of contact members.

16. The system of claim 14, wherein the tool body includes a second peripheral edge, the second peripheral edge has at least one curvilinear portion.

17. The system of claim 16, wherein the first hexagonal shape is configured to fit a nut of a housing cover of the pressure switch such that the first hexagonal shape removes the nut of the housing cover.

18. The system of claim 17, wherein the second hexagonal shape is configured to fit a nut of a pressure adjustment valve of the pressure switch such that the second hexagonal shape adjusts the nut position which in turn adjusts a pressure limit of the pressure switch.

19. A method of interrupting a power supplied to a pump by pressure switch for diagnostic testing, the method comprising:
removing, by a first hexagonal shape of a portable diagnostic tool, a nut of a housing cover to remove the housing cover from the pressure switch;
moving a diaphragm plate of the pressure switch to move a plurality of contact members from a closed position to an open position creating a gap between the plurality of contact members and a plurality of terminals;
inserting a leg of the portable diagnostic tool into the gap between a corresponding terminal member of the plurality of terminals and a corresponding contact member of the plurality of contact members such that the corresponding contact member of the plurality of contact members are prevented from making contact with the corresponding terminal member of the plurality of terminals and such that an abrasive surface of the legs cleans a carbon buildup on the each one the corresponding terminal member of the plurality of terminals; and
performing a diagnostic test on the pump to determine at least one from a continuity of a pump wires, a resistance of the pump wires, and a ground of the pump wires.

20. The method of claim 19, further comprising additional steps following the step of moving the diaphragm plate of the pressure switch to move the plurality of contact members from the first position to the second position:
inserting the legs into the gap between the plurality of contact members and the corresponding terminal member of the plurality of terminals such that the abrasive surface of the legs faces the plurality of contact members; and
removing the legs of the portable diagnostic tool from the gap between the corresponding terminal member of the plurality of terminals and the plurality of contact members such that the abrasive surface cleans a carbon buildup on the plurality of contact members.
